(19) United States
(12) Patent Application Publication
(10) Pub. No.: US 2026/0236230 A1
(43) Pub. Date: Aug. 13, 2026

(54) Method for Decoupling Front-End and Back-End Based On Distributed MVC Architecture

(71) Applicant: Guangzhou Yunbiaoju Network Technology Co., Ltd., Guangzhou Guangdong (CN)

(72) Inventor: Yadong ZHANG, Guangzhou Guangdong (CN)

(21) Appl. No.: 19/535,379

(22) Filed: Feb. 10, 2026

(30) Foreign Application Priority Data
Feb. 12, 2025 (CN) 202510153190.9

(51) Int. Cl. G06F 8/20; G06F 9/50

(52) U.S. Cl. CPC G06F 8/20; G06F 9/5038

(57) ABSTRACT

A method for decoupling a front-end and a back-end based on a distributed MVC architecture is disclosed. The method utilizes a modular processing unit in the back-end to unify the processing of controller and model objects. Through a lightweight communication protocol, business logic is completely decoupled from interface display. The front-end is configured to handle interface rendering and interaction event capture, while the back-end centrally processes complex logic. The method employs a resource identification mechanism to optimize data synchronization between the front-end and the back-end and utilizes JSON format for data transmission to reduce transmission volume and improve parsing efficiency. Additionally, a modular process separation design allows UI logic and compute-intensive tasks to run independently, ensuring high interface responsiveness and system stability.

### FIELD OF INVENTION

The present invention relates to the technical fields of software architecture design and front-end and back-end interaction, and more particularly, to a method for decoupling front-end and back-end based on distributed MVC.

### DESCRIPTION OF RELATED ARTS

MVC (Model-View-Controller) is a classic software architecture pattern that achieves modularization and clear responsibilities by separating data, user interface, and business logic, and is widely used in Web development and distributed systems. However, with the increase of high-interaction and complex business scenarios, the traditional MVC architecture has gradually exposed the following problems:
1. Excessive front-end load, affecting performance: In the traditional MVC architecture, the front-end is not only responsible for interface rendering, but also needs to process part of the business logic, which leads to a decrease in the interface response speed, which is particularly obvious in complex interaction scenarios.
2. Low front-end and back-end communication efficiency: Frequent interaction events require data to be transmitted between the front-end and the back-end, which is limited by network latency and transmission efficiency, resulting in a poor user experience.
3. High module coupling, poor scalability: The close association between the Controller and View layers makes it difficult to expand functions and maintain code, and may even affect system stability.

In order to solve the above problems, the prior art has tried to optimize system performance by enhancing back-end logic, introducing process isolation and resource identification mechanisms. For example, weakening front-end logic to reduce the burden, or improving stability through process separation, but these solutions often only solve a single problem, and it is difficult to provide comprehensive optimization in high-interaction and high-performance scenarios.

Therefore, how to achieve efficient decoupling of the front-end and back-end in complex systems, reduce complexity, and improve system response speed and scalability has become a technical problem to be solved by the present invention.

### SUMMARY OF THE PRESENT INVENTION

The technical problem addressed by the present invention is the provision of a method for decoupling a front-end and a back-end based on a distributed MVC architecture. This aims to overcome the defects in the prior art, specifically the issues of excessive front-end load, low communication efficiency between the front-end and back-end, and high module coupling in traditional MVC architectures within high-interaction scenarios.

To solve the above technical problems, the present invention adopts the following technical solution:

A method for decoupling a front-end and a back-end based on a distributed MVC architecture comprises: serializing, by a modular processing unit in the back-end, a controller object and a model object executing thereon into JSON data containing a controller object identifier, a model object identifier, and associated business logic, and transmitting the JSON data to the front-end; parsing, by the front-end, the received JSON data, binding the corresponding controller object and model object to a view object in the front-end, and rendering a user interface; capturing, by the front-end, an interaction event during user interaction with the user interface, and transmitting the interaction event to the controller object in the back-end via an instruction-based communication protocol; executing, by the controller object in the back-end, corresponding business logic based on the interaction event, and notifying the front-end of a processing result via the model object; and dynamically updating, by the front-end, the corresponding view object according to received updated data of the model object to reflect the processing result. The modular processing unit in the back-end includes a process model for coordinating task allocation, comprising a main process for handling user interaction logic and a worker process for task scheduling, wherein said worker process is configured for data storage and processing associated with the model object.

Preferably, the worker process of the process model comprises the following components:

a unified scheduling module for coordinating task allocation of the controller objects and the model objects, and managing communication between the front-end and the back-end;

a data storage module for processing disk IO operations and data persistence related to the model objects, so as to reduce direct coupling between the front-end and the task logic; and

a resource management module for parsing resource identifiers sent by the front-end, loading corresponding resources and synchronizing resource data to the front-end.

Preferably, the instruction-based communication protocol comprises the following:

a specific method name to be called;

a corresponding callback event identifier; and

a set of parameters required for transmitting the user interaction events.

Preferably, the updated data of the model objects is transmitted to the front-end in JSON format, the JSON format comprising unique identifiers of the model objects, descriptions of data structures, and data content for dynamically updating the view objects in the front-end.

Preferably, the method implements data synchronization between the front-end and the back-end through a resource identification mechanism, the resource identifiers being used for describing images, icons or prompts required by the interface components, and the front-end loading corresponding resources according to the resource identifiers to complete interface rendering.

Preferably, the view objects receive the JSON data transmitted by the back-end through a unified API, and the API supports rendering of multiple view components, comprising menu bars, toolbars, project trees, outlines and panels.

Preferably, the design of the process model follows a UI node separation architecture, and the interface presentation part and the computing-intensive task processing part run in independent processes to improve interface response speed and enhance system stability.

Preferably, the controller objects in the back-end dynamically select business logic processing paths based on the types of user interaction events, and notify the view objects in the front-end of the updated data through the model objects after completing the processing.

Compared with the prior art, the beneficial effects of the present invention are as follows:
1. By centralizing the business logic of the controller objects and the model objects in the back-end for processing, the front-end is "lightened", so that the front-end is only responsible for rendering the view and capturing interaction events. This back-end-driven design mode greatly reduces the front-end's computing burden and significantly improves the response speed of the interface. Especially in high-interaction application scenarios, the user experience is significantly optimized.
2. A modular process model is adopted, in which the UI interaction logic and computing-intensive tasks run in independent processes. The main process focuses on user interaction, and the worker process focuses on task scheduling and data processing. This design reduces the interference of task processing with interface interaction through function isolation, significantly improves system stability, and provides a good foundation for independent expansion of function modules.
3. The resource identification mechanism simplifies the complexity of front-end and back-end data synchronization. The back-end describes the resource information such as images and prompts required by the interface components in the form of resource identifiers, and the front-end dynamically loads the resources according to the identifiers. This mechanism effectively reduces the amount of data transmission, and supports rapid switching of multi-language internationalization, which enhances the flexibility and practicability of the system; and the JSON format is used to serialize and transmit the controller objects and the model objects. Compared with the traditional complex data structure, the JSON format has the characteristics of being lightweight and efficient in parsing, which makes the efficiency of data transmission and front-end parsing significantly improved, and further improves the overall performance of the system.

The additional aspects and advantages of the present invention will be given in part in the following description, and part will become obvious from the following description, or be understood by practicing the present invention.

### BRIEF DESCRIPTION OF THE DRAWINGS

In order to explain the technical solutions of the embodiments of the present invention or the prior art more clearly, a brief introduction to the drawings to be used in the description of the embodiments or the prior art will be given below. Obviously, the drawings described below are only some embodiments of the present invention. For those skilled in the art, other drawings can be obtained from these drawings without creative effort.

FIG. 1 is a basic structure diagram of a traditional MVC design pattern.

FIG. 2 is an MVC flowchart of the present invention.

FIG. 3 is a tree-shaped project creation process of the present invention.

FIG. 4 is a front-end and back-end interaction process of the present invention.

FIG. 5 is a flowchart of toolbar operation of the present invention.

### DETAILED DESCRIPTION OF THE EMBODIMENT

To make the objects, technical solutions, and advantages of the present invention clearer, the technical solutions of the present invention will be clearly and completely described below in conjunction with the drawings of the present invention. Obviously, the described embodiments are some, but not all, of the embodiments of the present invention. Based on the embodiments of the present invention, all other embodiments obtained by those skilled in the art without creative effort shall fall within the protection scope of the present invention.

In the present invention, OSE is short for ObjectSense language; Vim Peer is a general term for nodes started by various modules in the system on a device; and Vim Call is a general term for front-end and back-end nodes requesting ObjectSense interfaces within other nodes.

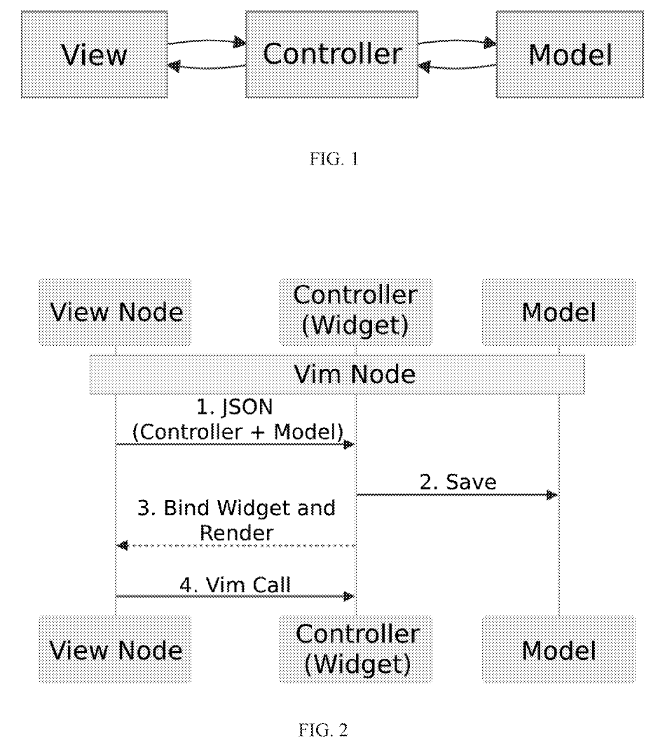

Please refer to FIGS. 1-5. In the embodiment of the present invention, a method for decoupling a front-end and a back-end based on a distributed MVC architecture, comprising: (a) serializing, by a modular processing unit in the backend, a controller object and a model object executing thereon into JSON-formatted data, wherein the JSON-formatted data comprises a controller object identifier, a model object identifier, and an associated business logic; (b) transmitting the JSON-formatted data to the frontend; (c) parsing, by the frontend, the received JSON-formatted data to bind the controller object and the model object to a view object in the frontend, and rendering a user interface; (d) capturing, by the frontend, an interaction event during user interaction with the user interface, and transmitting the interaction event to the controller object in the backend via an instruction-based communication protocol; (e) executing, by the controller object in the backend, a corresponding business logic based on the interaction event, and notifying the frontend of a processing result via the model object; and (f) dynamically updating, by the frontend, the view object according to received updated data of the model object to reflect the processing result; wherein the modular processing unit in the backend comprises a process model for coordinating task allocation between the controller object and the model object, the process model comprising a main process for processing user interaction logic and a worker process for task scheduling, wherein the worker process is configured to perform data storage and processing associated with the model object.

Preferably, the worker process of the process model comprises the following components:

A unified scheduling module for coordinating task allocation of the controller objects and the model objects, and managing communication between the front-end and the back-end; a data storage module for processing disk IO operations and data persistence related to the model objects, so as to reduce direct coupling between the front-end and the task logic; and a resource management module for parsing resource identifiers sent by the front-end, loading corresponding resources and synchronizing resource data to the front-end.

Preferably, the instruction-based communication protocol comprises the following: a specific method name to be called; a corresponding callback event identifier; and a set of parameters required for transmitting the user interaction events.

Preferably, the updated data of the model objects is transmitted to the front-end in JSON format, the JSON format comprising unique identifiers of the model objects, descriptions of data structures, and data content for dynamically updating the view objects in the front-end. The method implements data synchronization between the front-end and the back-end through a resource identification mechanism, the resource identifiers being used for describing images, icons or prompts required by the interface components, and the front-end loading corresponding resources according to the resource identifiers to complete interface rendering.

Preferably, the view objects receive the JSON data transmitted by the back-end through a unified API, and the API supports rendering of multiple view components, comprising menu bars, toolbars, project trees, outlines and panels; the design of the process model follows a UI node separation architecture, and the interface presentation part and the computing-intensive task processing part run in independent processes to improve interface response speed and enhance system stability; and the controller objects in the back-end dynamically select business logic processing paths based on the types of user interaction events, and notify the view objects in the front-end of the updated data through the model objects after completing the processing.

As shown in FIG. 1, the basic structure of a traditional MVC design pattern is illustrated. The View is responsible for interface display and user interaction, the Model provides data and rule support, and the Controller is responsible for transmitting and processing logic between the two. However, in the traditional model, the coupling degree between the View and the Controller is high, resulting in an excessive front-end load, which makes it difficult to meet the needs of high-interaction systems.

FIG. 2 describes the MVC design pattern process of the present invention. The back-end serializes the controller objects (Widget) and model objects into a JSON data through Vim nodes (Vim Peers), and transmits them to the front-end. The front-end receives and binds these data, completing interface rendering. During the user interaction process, the front-end transmits the events to the back-end through Vim calls (VimCall), and the back-end controller processes the business logic according to the events and saves the change results to the model, and notifies the front-end to dynamically update the interface again. This design simplifies the logic of the front-end to rendering and event capture, which greatly improves the response speed.

FIG. 3 illustrates the creation process of a tree-shaped project. Tree items (TreeItems) can be created through the front-end or back-end, and all project data is managed uniformly in the back-end, and finally, the interface is rendered by the front-end. This realizes the centralized processing of data and the dynamic update of the interface.

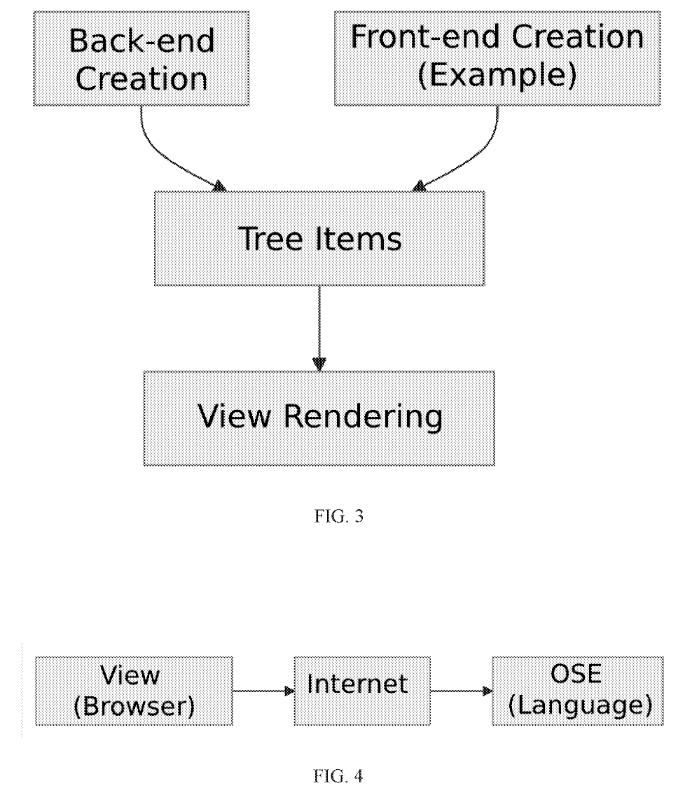

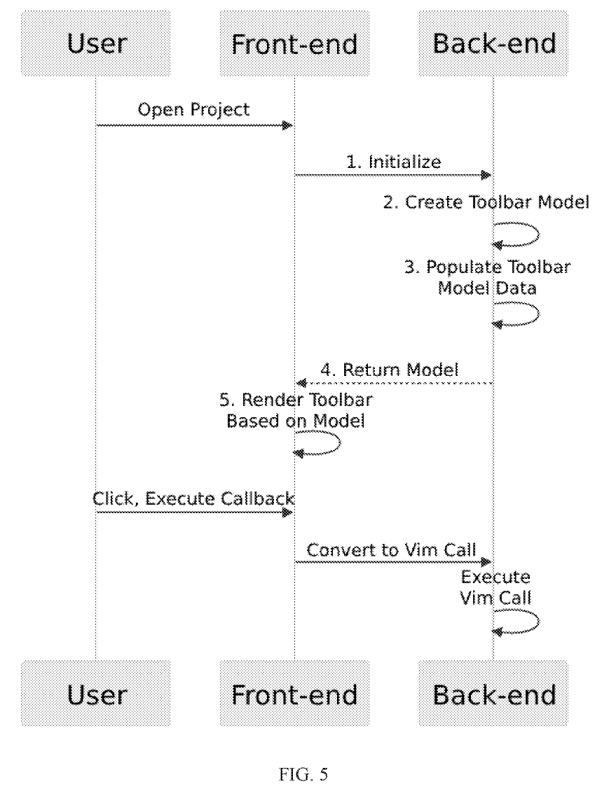

FIG. 4 shows the communication mechanism between the front-end and the back-end. The view layer (browser) interacts with the OSE module of the back-end through the Internet. The task of the front-end is limited to interface display and user input, while the back-end undertakes the main responsibility of data logic processing, which significantly reduces communication bottlenecks.

FIG. 5 shows a timing flowchart of toolbar operation. When the user opens the project, the front-end initializes and requests toolbar data from the back-end. The back-end creates a toolbar model, fills in the data, and returns it to the front-end. The front-end renders the toolbar interface according to the model. When the user clicks the toolbar button, the front-end converts the event into a Vim call and transmits it to the back-end. The back-end executes the corresponding operation logic. This design of separating the responsibilities of the front-end and back-end ensures the efficient rendering and dynamic response of the toolbar.

### Example 1

To better illustrate the technical solution of the present invention, the following takes a specific application scenario of a high-interaction distributed integrated development environment (IDE) as an example to show the implementation mode of the present invention and the technical effects achieved thereby.

In modern distributed IDEs, users need to manage multiple projects simultaneously, and frequently perform operations such as code editing, file operations, project structure viewing, and compilation. These operations place extremely high demands on the real-time responsiveness of the interface and the overall performance of the system. However, in the traditional MVC architecture, since the front-end needs to process a large number of operations related to business logic (such as file creation, parsing of compilation results, etc.), the interface response is slow, and the user experience is poor. In addition, frequent data interaction between the front-end and the back-end further slows down the system speed in the case of high network latency or large data volume. For example, during the dynamic update of the file tree (ProjectTree), the front-end needs to obtain data from the back-end according to the user's operation and render it in real time. This communication bottleneck is particularly prominent in complex scenarios.

The specific application of the front-end and back-end decoupling method based on distributed MVC of the present invention in this scenario is as follows:

First, in the scenario of dynamic update of the file tree, when the user clicks a directory node to expand the folder content, the front-end captures the user's click event, and sends the event to the controller object of the back-end through a lightweight communication protocol (such as VimCall instruction). The controller object determines the logical requirements of the user's operation according to the event type, for example, the user wants to obtain all file information under the directory. The back-end controller object extracts the data related to the directory from the model by calling the model object, including the file name, file type, and hierarchical structure. These data are serialized into a unified JSON format, and then transmitted to the front-end through the back-end modular processing unit.

In the front-end, the JSON format data is parsed by the view object and bound to the corresponding UI component (i.e., the node of the file tree). The rendering logic of the file tree is completely data-driven, and the front-end does not need to write additional business logic, thereby realizing the "lightweight" of the front-end code. At the same time, since the controller object and the model object are centrally processed in the back-end, the update speed of the file tree state is significantly improved, and the interface can respond to the user's interaction operations in real time. Even in complex projects with a large number of files and deep hierarchies, efficient performance can be maintained.

Secondly, for the user's possible multi-language needs, the present invention further improves the collaboration efficiency between the front-end and the back-end through the resource identification mechanism. For example, in the nodes of the file tree, the display name and corresponding icon information of each file or folder are uniformly provided by the back-end through resource identification. The front-end dynamically loads the corresponding image resources and language prompt information according to the identifier, thereby realizing the localization support and multi-language switching of the interface. This design reduces the amount of data transmitted between the front-end and the back-end, and improves the flexibility and adaptability of the interface rendering.

Taking the code editing function as an example, when the user inputs code in the editor, the front-end is only responsible for capturing the user's keyboard input and displaying the content in real time, while the back-end is responsible for processing the complex logic related to the code through the controller object, such as syntax highlighting parsing, error prompts, and code completion suggestions. These operation results are returned to the front-end in the form of model objects, and the display status of the editor is dynamically updated. For example, when the back-end detects a syntax error, the model object will package the error information (such as error type, line number, etc.) into JSON data and transmit it to the front-end. The front-end renders red underlines or pops up error prompt boxes according to these data. This processing method minimizes the complexity of the front-end and makes full use of the computing power of the back-end.

In addition, in terms of system stability and scalability, the present invention solves many pain points in the traditional architecture through the modular process model design. For example, in the above file tree update scenario, the UI logic runs in the main process, and the background controller and model objects run in an independent worker process (such as Lifter Peer). The main process focuses on capturing the user's interaction events and updating the interface, and the background process is responsible for processing data requests and complex computing tasks. This process isolation design not only improves the real-time responsiveness of the interface, but also avoids the interference of background tasks to the front-end interface operation. Even if the user performs complex operations (such as batch file operations) under high load conditions, the system can still maintain a smooth user experience.

Through the above embodiments, the present invention achieves comprehensive technical effects that cannot be achieved by the traditional MVC architecture. For example, the "lightweight" design of the front-end makes the interface response speed greatly improved, and the user interaction experience is significantly improved; the modular process model ensures the high stability and scalability of the system; the resource identification mechanism and the JSON data optimize the collaboration efficiency between the front-end and the back-end, reduce communication overhead, and enhance the flexibility of the system.

### Example 2

To more clearly demonstrate the technical solution of the present invention and its application effects, the following takes an application scenario of a distributed collaborative office system as an example to specifically illustrate how the new MVC model of the present invention solves the problems in the prior art and realizes technical effects.

In a distributed collaborative office system, users need to complete a variety of complex operations through the front-end interface, such as real-time editing of documents, multi-person collaborative management, viewing version records, and assigning permissions. These operations place extremely high demands on the dynamics, real-time nature, and complexity of the back-end business logic of the interface. Under the traditional MVC architecture, these scenarios usually encounter the following problems:
1. Excessive front-end load: In multi-person collaboration, the front-end needs to monitor the operations of other users in real time and update the document interface, and simultaneously process permission assignment logic and version switching logic. As the number of users and operation frequency increase, the load on the front-end continues to increase, resulting in interface lag and delay.
2. Front-end and back-end communication bottlenecks: For example, when a user adds a comment or modifies a document, the traditional architecture needs to send a large amount of operation details (including modified content, location, user information, etc.) from the front-end to the back-end for processing, and return the updated data for front-end rendering. This high-frequency, large-data transmission will seriously affect the efficiency of the system when the network conditions are poor.
3. High coupling between modules and insufficient scalability: The permission management module, version record module, and document editing module are often mutually dependent in the traditional architecture, and need to synchronize data between multiple modules, which increases the complexity of system expansion and makes it difficult to adapt to ever-changing business needs.

In response to the above problems, the application of the new MVC model proposed by the present invention in this scenario is as follows:

In the collaborative office system, each document is represented as a "model object" and is uniformly managed by the back-end. For example, a model object of a document will include the document content data, version information, permission configuration, etc. In the back-end, the controller object is specifically responsible for processing various operation requests of the user on the document, including content editing, version switching, permission modification, etc.

When a user opens a document, the front-end requests the back-end to obtain the model object data of the document through a lightweight communication protocol (such as VimCall instruction). The back-end serializes the model object into JSON format, and transmits the data including document content, permission configuration, and version information to the front-end. After parsing the JSON data, the front-end renders the document interface through the binding mechanism, such as displaying the document content, marking read-only areas or editable areas, and loading optional version switching options. In this way, the front-end only needs to focus on interface display and user interaction, avoiding heavy logical processing, thereby realizing a "lightweight" design.

In a multi-person collaboration scenario, when a user modifies a document, such as adding a comment under a certain piece of text, this operation is captured by the front-end and sent to the controller object of the back-end in the form of VimCall. The controller object updates the model object of the document according to the operation type, for example, adds a record to the comment data structure. The change of the model object is then serialized into JSON data and broadcast to the front-end interfaces of all users participating in the collaboration. The front-end of each user automatically updates the interface according to the received data, for example, displays the new comment content in the corresponding paragraph. This method uniformly processes business logic through the back-end, avoiding the front-end from performing complex operation synchronization logic, and significantly improves the performance and collaboration efficiency of the system.

For permission management, for example, the user wants to change the permission of a certain piece of text to "viewable only", this operation is also captured by the front-end and sent to the back-end for processing. The controller object of the back-end will update the model object according to the permission rules, and return the latest permission information to the front-end through JSON data. The front-end dynamically adjusts the interface display accordingly, for example, marks the text as gray, prompting it to be read-only. This method of updating the front-end interface driven by the back-end avoids the front-end from directly participating in complex permission logic judgment, and significantly reduces the complexity of the front-end code.

In version management, the present invention utilizes the resource identification mechanism to optimize the data interaction between the front-end and the back-end. For example, when the user switches the document version, the front-end does not directly load the complete version data, but sends a resource identifier to request the back-end to load the resources of the corresponding version. The back-end returns the simplified data of the version content according to the resource identifier, such as only including the content differences from the current version, and the front-end quickly updates the interface accordingly. This design not only reduces the amount of data transmitted between the front-end and the back-end, but also significantly improves the response speed of version switching, which is particularly effective when processing large-scale documents.

Furthermore, the system further improves overall stability through a modular process model design. For example, the UI process is responsible for real-time rendering of the interface and processing user operation events, while document content processing and permission verification logic run in independent background worker processes. This process isolation design ensures high responsiveness of the user interface, and even if the background processes complex requests from multiple users simultaneously, it will not affect the smoothness of the interface.

Through the above embodiments, the technical solution of the present invention achieves the following effects in the application of a distributed collaborative office system: performance improvement—by uniformly managing business logic and model objects in the back-end, and the front-end being only responsible for rendering the interface, the computational burden on the front-end is greatly reduced, and the response speed of the interface is significantly improved; collaboration efficiency improvement—through the unified management and real-time synchronization of model objects, the data consistency and real-time update of the interface during multi-user collaboration are ensured; communication optimization—using lightweight communication protocols and resource identification mechanisms reduces the amount of data transmission between the front-end and the back-end, and optimizes the use efficiency of network resources; and scalability enhancement—the modular process model design and the low-coupling module structure enable the system to flexibly adapt to diverse functional requirements, and facilitate maintenance and expansion.

Unless otherwise defined, all technical and scientific terms used herein have the same meaning as commonly understood by one of ordinary skill in the art to which this invention belongs. The terms "comprising," "including," "having," and their derivatives are used in an open-ended sense and do not exclude additional elements or steps. The phrase "connected to" or "coupled with" may include both direct and indirect connections through intermediate components. It will be apparent to those skilled in the art that the present invention is not limited to the specific details of the exemplary embodiments described above, and the present invention may be embodied in other specific forms without departing from the spirit or essential characteristics thereof. The embodiments are therefore to be considered in all respects as illustrative and not restrictive. The scope of the invention is indicated by the appended claims rather than the foregoing description, and all changes which come within the meaning and range of equivalency of the claims are intended to be embraced therein.

What is claimed is:

1. A method for decoupling a frontend and a backend based on a distributed MVC architecture, comprising:
(a) serializing, by a modular processing unit in the backend, a controller object and a model object executing thereon into JSON-formatted data, wherein the JSON-formatted data comprises a controller object identifier, a model object identifier, and an associated business logic;
(b) transmitting the JSON-formatted data to the frontend;
(c) parsing, by the frontend, the received JSON-formatted data to bind the controller object and the model object to a view object in the frontend, and rendering a user interface;
(d) capturing, by the frontend, an interaction event during user interaction with the user interface, and transmitting the interaction event to the controller object in the backend via an instruction-based communication protocol;
(e) executing, by the controller object in the backend, a corresponding business logic based on the interaction event, and notifying the frontend of a processing result via the model object; and
(f) dynamically updating, by the frontend, the view object according to received updated data of the model object to reflect the processing result; wherein the modular processing unit in the backend comprises a process model for coordinating task allocation between the controller object and the model object, the process model comprising a main process for processing user interaction logic and a worker process for task scheduling, wherein the worker process is configured to perform data storage and processing associated with the model object.

2. The method according to claim 1, wherein the worker process of the process model comprises: a unified scheduling module configured to coordinate task allocation of the controller object and the model object, and to manage communication between the front-end and the back-end; a data storage module configured to process disk IO operations and data persistence related to the model object, thereby reducing direct coupling between the front-end and task logic; and a resource management module configured to parse a resource identifier sent by the front-end, load a corresponding resource, and synchronize resource data to the front-end.

3. The method according to claim 1, wherein the instruction-based communication protocol comprises: a specific method name for invocation; a corresponding callback event identifier; and a set of parameters required for transmitting the user interaction event.

4. The method according to claim 1, wherein the updated data of the model object is transmitted to the front-end in a JSON format, said JSON format comprising a unique identifier of the model object, a data structure description, and data content configured for the front-end to dynamically update the view object.

5. The method according to claim 1, wherein the method implements data synchronization between the front-end and the back-end through a resource identification mechanism, wherein a resource identifier is used to describe an image, an icon, or a prompt required by an interface component, and the front-end loads a corresponding resource according to said resource identifier to complete interface rendering.

6. The method according to claim 1, wherein the view object receives the JSON data transmitted by the back-end through a unified API, and said API supports rendering of a plurality of view components, comprising a menu bar, a toolbar, a project tree, an outline, and a panel.

7. The method according to claim 1, wherein the process model is configured such that an interface presentation part and a compute-intensive task processing part run in independent processes to improve interface response speed and enhance system stability.

8. The method according to claim 1, wherein the controller object in the back-end dynamically selects a business logic processing path based on a type of the user interaction event, and notifies the view object in the front-end of the updated data through the model object after completing the processing.
